(19) United States
(12) Patent Application Publication
(10) Pub. No.: US 2017/0116564 A1
(43) Pub. Date: Apr. 27, 2017

(54) METHOD AND SYSTEM FOR TRANSFERRING OBJECT ACROSS ONE OR MORE GEOGRAPHICAL AREAS

(71) Applicant: BEIJING CO-LINK WORD TECHNOLOGY CO. LTD, Beijing (CN)

(72) Inventor: Huilin LUO, Macheng (CN)

(21) Appl. No.: 15/372,531

(22) Filed: Dec. 8, 2016

Related U.S. Application Data
(63) Continuation-in-part of application No. 13/979,814, filed on Jul. 15, 2013.

(51) Int. Cl. G06Q 10/08

(52) U.S. Cl. CPC G06Q 10/083; H04L 67/10

(57) ABSTRACT

Embodiments of the present application provide an object transfer system for transferring an object from a source address to a destination address through nodes across one or more geographical areas, the system comprising an intelligent object distribution platform and a plurality of nodes each located in a respective geographical area. The platform, the nodes and users can communicate with each other in a wired manner or in a wireless manner. The platform is configured to associate nodes located in each geographical area to form a number of tree structures with respective roots of said trees being connected with each other; and said roots in each geographical area are all connected to one of other nodes which are not part of any tree structure and which in turn are connected to each other. The platform is further configured to select a route associated with for the object, instruct the nodes on the selected route to transport the object; wherein in response to receiving a message from a node that an object has arrived at the node, the platform sends a message to inform the node of the next node in the unique shortest route for the object, and sends a message to inform the next node there will be an object arriving at.

### CROSS-REFERENCE TO RELATED APPLICATIONS

The present application is a continuation-in-part application of the U.S. application Ser. No. 13/979,814, filed on Jul. 15, 2013, titled “LOGISTICS SYSTEM AND A METHOD FOR PROVIDING LOGISTICS SERVICE WITH THE LOGISTICS SYSTEM”, which is a national phase application under 35 U.S.C. §371 of International Application No. PCT/CN2011/070807 filed 30 Jan. 2011. The entire content of these applications are incorporated in the present application by reference.

### TECHNICAL FIELD

The present invention relates to the field of object transfer, and in particular relates to the field of logistics service.

### BACKGROUND

Currently, as the economy grows all over the world, especially with the rapid development of E-commence, more and more goods are delivered from one place to another place every day and the logistics service is playing an increasingly important role in social and economical life. At present the logistics service is carried out by different logistics companies located everywhere in the world. These logistics companies determine their own service quality, service price and service scope and there is little coordination between them due to the severe competition. For instance, when one wants to deliver goods to another, he must fill the set of five copies, and then the logistics company sends the goods according to the copies information. In the process, if the logistics company commissions the task to another company, the delivery information will be lost, resulting in a chaos in the operation procedure. Therefore, the consigner cannot get all the information for the delivery process. This is terrible for the industry users. These limiting factors have made the logistics service a bottleneck for the society, especially for the E-commence and have resulted in low delivery efficiency, high service cost and a waste of resources.

Therefore, a logistics system is desired, which is expandable so as to reach anywhere in the world and which is capable of integrating and coordinating various types of social resources to achieve an efficient and less-expensive delivery of goods.

### SUMMARY OF THE INVENTION

According to a first aspect of the present invention, there is provided an intelligent object distribution platform for use in transferring an object through nodes across one or more areas, said platform comprising: a node subsystem configured to maintain information about nodes and relationships between nodes; and a user subsystem configured to maintain users' information; an ID subsystem configured to manage and maintain a unique ID for each object; a processing subsystem configured to select a route associated with the ID based on said user information and said relationship between nodes; wherein in the node subsystem nodes located in each area are associated to form a number of tree structures with respective roots of said trees being connected with each other such that the processing subsystem is capable of deriving a unique shortest route from a node to another node for the object.

According to a first aspect of the present invention, said roots in each area are all connected to one of other nodes which are not part of any tree structure and which in turn are connected to each other such that the processing subsystem is capable of deriving a unique shortest route across a plurality of areas for the object.

According to a first aspect of the present invention, said platform is configured to be used in logistics service and said areas are geographical areas.

According to a first aspect of the present invention, said platform is configured to be used in data transmission and said areas are network areas.

According to a first aspect of the present invention, said processing system controls the transferring process according to the ID.

According to a first aspect of the present invention, said user information comprises address information of a consigner and a consignee, their respective access nodes and logistics expense.

According to a first aspect of the present invention, said ID is provided by the platform or by the user.

According to a first aspect of the present invention, said node subsystem further maintains information about the service scope, service price and service time of nodes and said processing subsystem calculates the logistics expense.

According to a first aspect of the present invention, said ID comprises RFID, two dimensional codes, bar codes or an ID on a standard box.

According to a first aspect of the present invention, said standard box comprises a sealing label.

According to a first aspect of the present invention, each area comprises a plurality of region each of which in turn comprises a plurality of sub-regions, and in each tree structure a root is formed by a Regional Distribution Center and non-root nodes in each tree structure are each formed by a Distribution Centers or a hub in which a hub can only be a leaf of the tree structure and its parent node can only be a DC, wherein a Distribution Center is responsible for logistics delivery in a sub-region and a Regional Distribution Center is responsible for logistics delivery across regions or across sub-regions, said other nodes are formed by country distribution centers which is responsible for logistics delivery across areas, and wherein the object transfer between two directly connected nodes is provided by the parent node except for two connected regional distribution centers or two connected country distribution centers, between which the logistics delivery is negotiated.

According to a first aspect of the present invention, said hub is formed by any individual or social entity who is willing and capable of providing the functions of collecting and taking custody of goods.

According to a second aspect of the present invention, there is provided an object transfer system for transferring an object across one or more areas, said system comprising: a plurality of nodes each located in a respective area configured for providing object transfer function; and an intelligent object distribution platform configured to communicate with each node and select a route consisted of said nodes for the object; wherein nodes located in each area are arranged to form a number of tree structures with respective roots of said trees being connected with each other such that the intelligent object distribution platform is capable of deriving a unique shortest route for the object.

According to a second aspect of the present invention, said roots in each area are all connected to one of other nodes which are not part of any tree structure and which in turn are connected to each other such that the intelligent object distribution platform is capable of deriving a unique shortest route for the object across a plurality of areas.

According to a second aspect of the present invention, said system is a logistics system and said areas are geographical areas.

According to a second aspect of the present invention, said system is a data transmission system and said areas are network areas.

According to a second aspect of the present invention, during the object transfer there is a unique ID associated with the object.

According to a second aspect of the present invention, each area comprises a plurality of region each of which in turn comprises a plurality of sub-regions, and in each tree structure a root is formed by a Regional Distribution Center and non-root nodes in each tree structure are each formed by a Distribution Centers or a hub in which a hub can only be a leaf of the tree structure and its parent node can only be a DC, wherein a Distribution Center is responsible for logistics delivery in a sub-region and a Regional Distribution Center is responsible for logistics delivery across regions or across sub-regions, said other nodes are formed by country distribution centers which is responsible for logistics delivery across areas, and wherein the object transfer between two directly connected nodes is provided by the parent node except for two connected regional distribution centers or two connected country distribution centers, between which the logistics delivery is negotiated.

According to a second aspect of the present invention, said hub is formed by any individual or social entity who is willing and capable of providing the functions of collecting and taking custody of goods.

According to a second aspect of the present invention, each node provides its service scope of the radiation area, service time and service price to the platform.

According to a second aspect of the present invention, said system is expandable.

According to a third aspect of the present invention, there is provided a method for transferring an object from a source address to a destination address across one or more areas through nodes located in said areas, said method comprising: arranging nodes in each area to form a number of tree structures with respective roots of said trees being connected with each other and arranging said roots in each area to all connect to one of other nodes which are not part of any tree structure and which in turn are connected to each other; selecting for the object a source node and a destination node corresponding to the source address and the destination address respectively; deriving a unique route consisted of nodes for the object; and transporting the object along the route.

According to a third aspect of the present invention, the object is transferred together with a unique ID associated with it and wherein the ID is used to trace the object during transferring.

According to a third aspect of the present invention, during the transfer each node involved in the route only knows its next node.

According to a third aspect of the present invention, said method is used for providing logistics service.

According to a third aspect of the present invention, said method is used for transmitting data.

According to a fourth aspect of the present invention, there is provided an intelligent logistics distribution platform for use in providing logistics service across one or more areas, said platform comprising: a node subsystem configured to maintain information about nodes used for providing logistics delivery and relationships between said nodes; and a user subsystem configured to maintain users' information; an ID subsystem configured to manage and maintain a unique ID for each logistics service; a processing subsystem configured to select a route associated with the ID for the logistics service based on said user information and said relationship between nodes; wherein in the node subsystem nodes located in each area are associated to form a number of tree structures with respective roots of said trees being connected with each other such that the processing subsystem is capable of deriving a unique shortest route for the logistics service.

According to a fourth aspect of the present invention, said roots in each area are all connected to one of other nodes which are not part of any tree structure and which in turn are connected to each other such that the processing subsystem is capable of deriving a unique shortest route across a plurality of areas for the logistics service.

According to a fourth aspect of the present invention, said processing system controls the logistics service process according to the ID.

According to a fourth aspect of the present invention, said user information comprises address information of a consigner and a consignee, their respective access nodes and logistics expense.

According to a fourth aspect of the present invention, said ID is provided by the platform or by the user.

According to a fourth aspect of the present invention, said node subsystem further maintains information about the service scope, service price and service time of nodes and said processing subsystem calculates the logistics expense.

According to a fourth aspect of the present invention, said ID comprises RFID, two dimensional codes, bar codes or an ID on a standard box.

According to a fourth aspect of the present invention, said standard box comprises a sealing label.

According to a fourth aspect of the present invention, each area comprises a plurality of region each of which in turn comprises a plurality of sub-regions, and in each tree structure a root is formed by a Regional Distribution Center and non-root nodes in each tree structure are each formed by a Distribution Centers or a hub in which a hub can only be a leaf of the tree structure and its parent node can only be a DC, wherein a Distribution Center is responsible for logistics delivery in a sub-region and a Regional Distribution Center is responsible for logistics delivery across regions or across sub-regions, said other nodes are formed by country distribution centers which is responsible for logistics delivery across areas, and wherein the logistics delivery between two directly connected nodes is provided by the parent node except for two connected regional distribution centers or two connected country distribution centers, between which the logistics delivery is negotiated.

According to a fourth aspect of the present invention, said hub is formed by any individual or social entity who is willing and capable of providing the functions of collecting and taking custody of goods.

According to a fifth aspect of the present invention, there is provided an logistics system for providing logistic service across one or more areas, said system comprising: a plurality of nodes each located in a respective area configured for providing logistics delivery; and an intelligent logistics distribution platform configured to communicate with each node and select a route consisted of said nodes for the logistics service; wherein nodes located in each area are arranged to form a number of tree structures with respective roots of said trees being connected with each other such that the intelligent logistics distribution platform is capable of deriving a unique shortest route for the logistics service.

According to a fifth aspect of the present invention, said roots in each area are all connected to one of other nodes which are not part of any tree structure and which in turn are connected to each other such that the intelligent logistics distribution platform is capable of deriving a unique shortest route for the logistics service across a plurality of areas.

According to a fifth aspect of the present invention, during the logistics delivery there is a unique ID associated with the logistics service.

According to a fifth aspect of the present invention, each area comprises a plurality of region each of which in turn comprises a plurality of sub-regions, and in each tree structure a root is formed by a Regional Distribution Center and non-root nodes in each tree structure are each formed by a Distribution Centers or a hub in which a hub can only be a leaf of the tree structure and its parent node can only be a DC, wherein a Distribution Center is responsible for logistics delivery in a sub-region and a Regional Distribution Center is responsible for logistics delivery across regions or across sub-regions, said other nodes are formed by country distribution centers which is responsible for logistics delivery across areas, and wherein the logistics delivery between two directly connected nodes is provided by the parent node except for two connected regional distribution centers or two connected country distribution centers, between which the logistics delivery is negotiated.

According to a fifth aspect of the present invention, said hub is formed by any individual or social entity who is willing and capable of providing the functions of collecting and taking custody of goods.

According to a fifth aspect of the present invention, each node provides its service scope of the radiation area, service time and service price to the platform.

According to a fifth aspect of the present invention, said system is expandable.

According to a sixth aspect of the present invention, there is provided a method for transferring goods from a source address to a destination address across one or more areas using nodes each located in a respective area for providing logistics delivery, said method comprising: arranging nodes in each area to form a number of tree structures with respective roots of said trees being connected with each other and arranging said roots in each area to all connect to one of other nodes which are not part of any tree structure and which in turn are connected to each other; selecting from said nodes for the goods a source node and a destination node corresponding to the source address and the destination address respectively; deriving a unique route consisted of nodes for the goods; and transferring the goods along the route.

According to a sixth aspect of the present invention, the goods is transferred together with a unique ID associated with it and wherein the ID is used to trace the goods during transferring.

According to a sixth aspect of the present invention, during the transfer each node involved in the route only knows its next node.

### BRIEF DESCRIPTION OF DRAWINGS

Features and advantages of the present invention will be apparent from the detailed description which follows, taken in conjunction with the accompanying drawings, which together illustrate by way of example features of the present invention; and wherein:

FIG. 1 illustrates the schematic diagram of model for the logistics system according to the present invention;

FIG. 2 illustrates the block diagram of an intelligent logistics distribution platform according to the present invention;

FIG. 3 illustrates a flow chart of the account application and registration of the logistics service provider node in the intelligent logistics distribution platform;

FIG. 4 illustrates a flow chart of the account application and registration of logistics services consuming business user in the intelligent logistics distribution platform;

FIG. 5 illustrates a flow chart of account application and registration of logistics services consuming individual user in the intelligent logistics distribution platform;

FIG. 6 illustrates a flow chart of logistics operation process according to the present invention;

FIG. 7 illustrates the schematic diagram of an object transfer system according to the present invention;

FIG. 8 illustrates the block diagram of intelligent object distribution platform for use in transferring an object through nodes across one or more geographical areas according to the present invention; and

FIG. 9 illustrates a flow chart of a method for transferring an object from a source address to a destination address across one or more geographical areas according to the present invention.

### DETAILED DESCRIPTION OF THE INVENTION

In the following the preferred embodiments of the present invention will be described in detail. Specifically, the idea of the logistics system according to the present invention will be first introduced in the first subsection. Next, the transmission principle of IP packet data will be described in the second subsection. Then, the general concept of logistics and the similarity between goods distribution and IP data transmission will be described in the third and fourth subsection. Then the system model of the logistics system of the present invention and its operating rules as well as the operating process will be described in detail.

It should be noted that although the present invention is described with reference to goods delivery in the following, the principle of the present invention can also be applied in various areas and can be used to transfer other objects, including but not limited to data, material or components in a factory, etc. The logistics is only used as an example to illustrate the principle of the present invention.

I. Introduction

It has been observed that when introducing the data transmission principles in textbooks, goods distribution, especially the letter delivery by Post office, is always used as an example. Perhaps, when DAPRA designed the original APRA net, they did refer to the postal operation system. The network has gone through about over 40 years of rapid development, and the routing architecture evolved from the core routing architecture to peer architecture. Since the Internet network can have such rapid developments and progresses and it brought to the society so much convenience, the inventor realized that a logistics and distribution system can be designed. Based on this idea, the inventor designs a logistics system which combines e-commerce and software technology. The logistics system is open, scalable and intelligent. It will achieve large-scale distribution, intelligence and cost optimization.

II. IP Packet Data Transmission Principle

TCP/IP protocols (Transfer Control Protocol/Internet Protocol) are the bases for data transmission across Internet. TCP/IP protocols, also known as network communication protocols, are the basic communication protocols in Internet.

The basic transmission unit for TCP/IP is the IP datagram packet. The IP datagram format is shown in Table 1. TCP protocol is responsible for dividing data into several packets, and then IP protocol assigns the end host address on the each data header, so that every datagram can find its own routing path. IP protocol ensures data transmission; and TCP protocol ensures data transmission quality.

TABLE 1
The IP datagram formats

| | | | |
|---|---|---|---|
| Version | IHL | TOS | TL |
| (4 bits) | (4 bits) | (1 byte) | (2 bytes) |

| | | |
|---|---|---|
| Identification | Flags | Fragment Offset |
| (2 bytes) | (3 bits) | (13 bits) |

| | | |
|---|---|---|
| TTL | Protocol | Header Checksum |
| (1 byte) | (1 byte) | (2 bytes) |

Source Address (4 bytes)
Destination Address (4 bytes)
Options
Padding
Data

Routing is an important function for IP. It is mainly used to determine the best path to the target host. In the network, each device connected to the network has its own IP address. That makes the data package destination address and network device address have an one-to-one correspondence. The routers in the network can uniquely determine the destination IP address and then route and forward the data packets. Routing and forwarding are two basic functions for a router.

Routing is to determine the best path to reach the destination, which is carried out by the routing algorithm. Routing algorithm maintains the routing table that contains routing information. Routing algorithm fills different information collected from other routers into the routing table. Routing table tells the next hop to the router. Routers exchange information with each other to update and maintain the routing table to make it accurately reflects the network topology changes. The router determines the best path according to all kinds of measurements.

Transmission refers to sending a data packet along the best path that has been assigned. Firstly, a router checks the routing table to find how to send the packet to the next site (router or host). If the destination network router directly connected to the router, then it will send the data packet to the corresponding port on the destination network router. A typical routing protocol has two ways: one is static routing, and the other is dynamic routing. In static routing a fixed routing table is set in the router. In dynamic routing, routers between the networks communicate and exchange routing information with each other. Dynamic routing can adapt to the network changes in the structure in real-time. If the routing update information finds some changes occurring in the network, the routing software will recalculate the route, and issue a new routing. This information will be broadcast to other routers through network, causing other router to restart its routing algorithm, and update their routing tables to reflect the network topology changes dynamically.

Routing algorithm plays a crucial role in routing protocols; and it determines the final routing results. Routing algorithm uses a number of different metrics to determine the best path. Complex routing algorithm may use various metrics to choose the route, such as: path length, reliability, delay, bandwidth, load, communication costs, etc.

III. Logistics and Distribution

A general definition of distribution is that it is a process that the logistics node delivers the goods form a consigner to a consignee. Logistics and distribution must accomplish the following task: getting the right goods at the right location and right time, and then sending them to the right consignee at the right time, namely 5R principles. We can find that the initiation of logistics and distribution requires the following conditions:
1) The addresses, including the initial shipping address (source address), and the consignee address (destination address);
2) Time requirements, including pickup and delivery time;
3) The relevant contact persons; and
4) The basic properties of the goods, such as weight, volume, relevant physical and chemical properties.

Using a format similar to the IP datagram, the above listed information can be shown as follows (Table 2):

TABLE 2
The orders of goods to distribute

| | |
|---|---|
| Source address | Destination address |
| Pickup time | Delivery time |
| Consigner | Consignee |

The basic properties of goods

| | | | |
|---|---|---|---|
| Weight | Volume | Shape | Frangible |
| Corrosive | Poisonous | . . . | |

Other Information

A logistics and distribution undertaker needs to select the most suitable path to deliver the goods based on the above information.

IV. Similarities Between IP Packets Transmission and Goods Distribution

According to the above description in regard to IP data packet transmission and description about the logistics and distribution, we can find that they have a number of similarities:

1) Both IP data packets transmission and goods distribution require the change of position. IP data packets are transferred from one network node to another network node; while actual goods are transferred from one location to another location. They both need accurately reach the correct destination.

2) A transmission route needs to be determined for both IP data packets and goods. The transmission route for IP data packets is determined by the router based on the routing table; while with regard to the actual goods, the logistics and distribution company will determine the route according to the goods requirements, transport means, path etc.

3) Routers and logistics and distribution companies do the same work “store-forward”. Routers store and forward the IP data packets; while logistics and distribution companies store and forward the goods.

According to these similarities, one can abstract the goods distribution as the IP data packet transmission:

1) The goods is abstracted as IP data packet, the consigner address as the source address, and the consignee address as the destination address.

2) The logistics and distribution network is abstracted as the Internet network, and the transport path between nodes as the network route that is connected by transmission media.

3) The goods transport routing is abstracted as the network routing. Both the goods and the IP data packets need to build an available Unicom path from the source address to the destination address.

As is clearly seen from the above analysis, logistics and distribution network should be organized as the Internet network. Every logistics node is organized as a network router. The goods being transmitted in the logistics network is just as the IP data packets being transmitted in the Internet network. Every goods can choose the best path to distribute as the routing algorithm chooses the best route for the data packets.

V. Logistics System and Logistics Service Method of the Invention

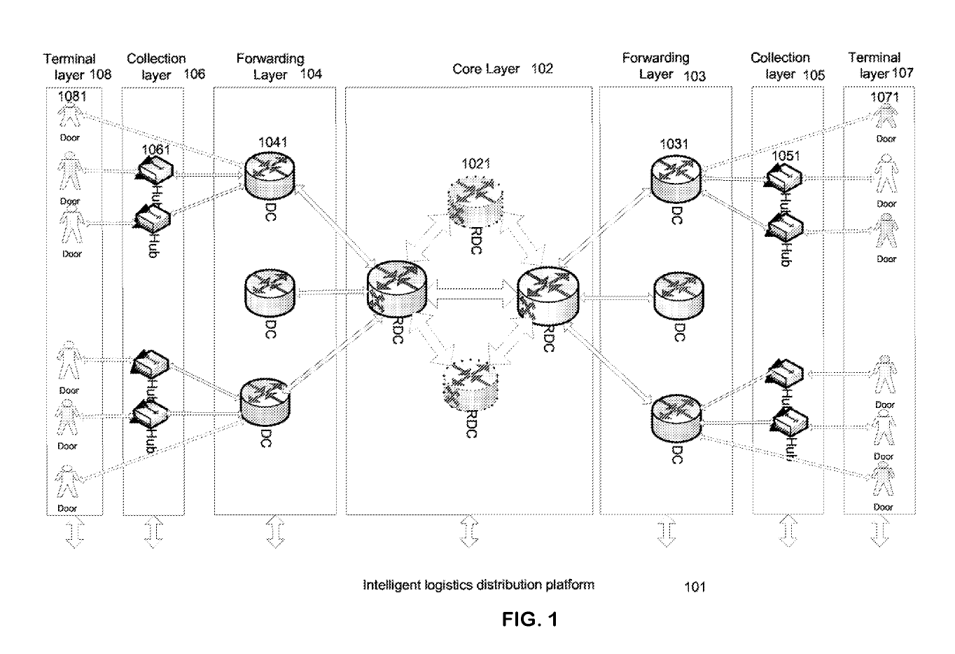

FIG. 1 illustrates the schematic diagram of the logistics system according to the present invention. In FIG. 1, the logistics system 100 comprises an intelligent logistics distribution platform 101, a core layer 102, two forwarding layers 103 and 104, two collecting layer 105 and 106 and two terminal layer 107 and 108. The core layer 102 comprises four nodes formed by regional distribution centers (RDC) such as 1021. RDCs connected with each other, as shown by the solid two-way arrows. The forwarding layers 103 and 104 comprise three nodes formed by distribution centers (DC) such as 1031 and 1041, respectively. The collecting layers 105 and 106 respectively comprise four hubs such as 1051 and 1061. According to the present invention, a hub is not a professional logistics company. It can be any social resource which can participate in the logistics service. The terminal layers 107 and 108 respectively comprise six doors such as 1071 and 1081. In the present invention, a door represents an end user of the logistics service, such as a consigner or a consignee. For example, the consigner can be located in terminal layer 108 and the consignee can be located in terminal layer 107. Please be noted that the nodes in each layer are just shown for illustration, and that the number of nodes comprised in each layer is not limited to the number shown in the Figure and there can be any reasonably suitable number of nodes in each layer, as can be appreciated by one skilled in the art. Also, please be noted that, for the purpose of better understanding, in FIG. 1 there are illustrated two forwarding layers 103 and 104, two collecting layers 105 and 106 and two terminal layers 107 and 108, so as to schematically explain that layers 104, 106 and 108 represents for example one side of the logistics service (e.g. consigner side) and layers 103, 105 and 107 represents the other side of the logistics service (e.g. the consignee side) and that goods is sent for example from the consigner, through layers 106, 104, 102, 103 and 105, to the consignee. However, it should be understood that it is not necessary for the logistics system of the present invention to comprise two terminal/collecting/forwarding layers and that these two terminal/collecting/forwarding layers can be combined into a terminal/collecting/forwarding layer respectively. Also, as previously mentioned, the present invention is not limited to the field of logistics but can be applied to other object-transferring related fields, in which case the logistics system can be referred to as an object transfer system and the intelligent logistics distribution platform can be referred as an intelligent object distribution platform accordingly.

As can be seen from FIG. 1, RDCs 1021 are interconnected with each other in the core layer 102. Each DC in the forwarding layer 104 or 103 is connected to either another DC or an RDC, as shown by the two-way solid arrows such as arrow 1400. Please be noted that each DC must have and only have one connection to another DC or an RDC. Each hub in the collecting layer 105 or 106 is connected to a DC, as shown by the two-way solid arrows. Please be noted that each hub must have and only have one connection to a DC. Each door in the terminal layer 108 or 107 is connected to a hub or a DC, as shown by two-way dashed arrows. The two-way arrows, whether it is solid arrow or dashed arrow, in FIG. 1 indicates that logistics delivery occurs between two parties on the ends of the arrow. The dashed arrows indicate that the nodes in terminal layer 107 or 108 only connect to the logistics system when they need logistics service. Two-way arrows between these layers and the intelligent logistics distribution platform indicates that these layers communicate with the platform, either in a wired manner or in a wireless manner, as one skilled in the art can appreciate.

In operation, all the nodes in these four layers need to be registered and described in the platform, and appropriate relationships should be established between them, as described below in detail.

1) Core layer: Core layer can be divided into two layers, although there is only illustrated one layer in FIG. 1. The upper layer is consisted of CDCs (country distribution center). The lower layer is consisted of RDCs.

a. The CDCs of the upper layer are responsible for international cargo transportation. When a CDC is being built, it is connected with other CDCs by default, but whether this connection becomes effective is subject to the final determination of the platform. The single logistics operation and sorting cost inside a CDC are defined by CDC itself and monitored by the platform, but the transshipment charges between CDCs are to be negotiated between such three parties as the two CDCs and the platform, and to be approved by the platform. CDC is the root node of RDC. When goods is transmitted between a CDC and an RDC, the CDC is responsible for providing logistics delivery, so the CDC needs to declare its scope of radiation area and service prices on the platform, and wait for the access of the RDC.

b. The RDCs of the lower layer are mainly for receiving and forwarding goods between large areas in one country. RDCs are generally taken by powerful logistics companies. An RDC chooses an access CDC itself, and the CDC determines its final effectiveness, i.e. determines whether to approve an RDCs access or not. The RDCs of a country are connected with one another to form a cross-network structure. The single logistics operation and sorting cost inside an RDC are defined by the RDC itself and monitored by the platform, but the transshipment charges between RDCs are to be negotiated between such three parties as the two RDCs and the platform, and be approved to go into effect by the platform. When a logistics company has registered at the platform as an RDC, it needs to declare its scope of radiation area and service prices on the platform according to its service capacity, and wait for the access of the DC.

2) Forwarding Layer: Forward layer is composed of DCs. DCs are the RDCs' child nodes, or grandchild nodes. RDCs are the root of the forwarding layer. A DC may take another DC as its parent node. DCs are generally taken by a logistics company of profession qualification within a region. After a logistics company has registered at the platform, it may select a parent node for access according to its own situation. This node can be an RDC that serves this region, or another DC that serves in the same region. Each DC can access only one node. Once the DC has accessed, it must state its radiation area on the platform, as well as the single operation cost and transfer completion time. Every DC can choose its best parent node. The final effectiveness of DC accessing parent node is subject to its parent node's approval.

3) Collecting layer: Collecting layer nodes are defined as Hub. The parent node a Hub can connect to be DC only. Each Hub can have only one parent node. Hub is generally not a professional logistics company. It can be any social resource. When an entity has registered as a Hub, it needs to provide to the platform the service time window, collecting area and the corresponding service remuneration, such as: each item's collecting costs, and overtime storage costs. Each hub has the right to choose its best parent node. The final effectiveness of Hub accessing DC is subject to its parent DCs approval.

4) Terminal layer: Terminal layer is the end-user, including the consigner and the consignee. They are the final leaf nodes. They use logistics resources only when they need. When they need logistics service, they should specify the available logistics nodes: DCs or Hubs that can provide logistics services. They bear the costs of logistics services.

During logistics service, each node carries out its task according to a set of operating rules, which are defined as follows: 1) The forwarding between CDCs is negotiated between CDCs themselves, but CDCs shall provide logistics service to the accessed RDCs. 2) The forwarding between RDCs is negotiated between RDCs themselves, but RDCs shall provide logistics service to the accessed DCs. 3) The logistics services between DC and DC, DC and Hub as well as DC and Door are all undertaken by the parent nodes for the child nodes. 4) Hub does not undertake the pickup and delivery service, but just performs the function of collecting and taking custody of the goods. 5) If the goods are two nodes or more away from the consignee, the consignee may modify the final node and destination address of the goods to change the route for the goods. The additional expenditure produced thereby is to be borne by the consignee.

According to one embodiment, the general operating process of the logistics system (or in general an object transfer system) of the present invention is briefly described as follows:

1) The consigner first needs to obtain an ID as the unique ID of this logistics service. According to the preferred embodiment of the present invention, the consigner could use the standard box (which will be described later) provided by the platform, within which is embedded a unique RFID. In this case the standard box and the RFID tag both can be recycled and reused. Of course, the consigner could use other containers for the goods and could obtain other forms of ID in various ways, such as permanent RFID tag, two dimensional codes or bar codes. If the user uses a standard box, he may apply for his own dedicated sealing label to make sure that the sealed box is tamper evident, and he may also apply for a delivery identification label to identify the precautions that require notice during the transfer of the goods, such as “Fragile, Handle Carefully”, “Keep This Side Up”, “Keep Off Moisture” and so on. 2) The consigner enters this unique ID into the platform and the platform informs the consignee of this ID. Then both the consigner and the consignee need to select their respective access nodes in the platform. Once the consigner and the consignee have selected access nodes, the platform automatically establishes a logistics route that connects the consigner to the consignee. When the consigner enters information about the goods such as the weight, volume and value of the goods into the platform, corresponding logistics charge will be automatically calculated by the platform. According to one embodiment, said charge is paid to the platform in advance by either the consigner or the consignee. Alternatively, the charge may be paid after the delivery is finished. 3) In the present embodiment, upon payment of the logistics charge, the logistics delivery starts. Every node involved in the route sequentially performs the transport of the goods according to the requirement of the user and the promise to the platform. After receiving the goods, every node must sign to the platform, whether by an automatic scanning technique, or by a manual signing method. Only after a current node signing to the platform will the platform notify the current node the next flow node of the goods. This process repeats until the goods finally reach the consignee. During the above operation, every node abides by the following operation list:

TABLE 3
Operation Table of Each Node

| | | | | | | | | |
|---|---|---|---|---|---|---|---|---|
| | | | | | | | Estimated | |
| | | | | | | | Sign-In | |
| | | Current | Sign- | Inbound | Outbound | Next | Time for | |
| No. | ID | Node | In | Time | Scan Time | Node | Next Node | Others |

[symbol]

[symbol]

indicates data missing or illegible when filed

In this table, No. represents the number of nodes the goods passes, ID is the unique ID mentioned above, current node represents a node that currently hold the goods, sign-in represents the fact that the node have received the goods and signed for it, inbound sign-in time represents the time the node signed when it received the goods, outbound scan time represents the time the node starts to deliver the goods to the next node, next node represents the next stop the goods should be going to, estimated sign-in time for next node represents the time it is expected for the next node to receive the goods and sign in, and others represents other information about the goods. 4) Once the goods reaches the consignee, the consignee finally signs to the platform. The signing of the consignee signifies the successful completion of this logistics operation. Then the platform distributes the logistics income to the nodes involved in this process. In case a standard box is used, the standard box and permanent RFID tag that fall into the hands of the consignee can either be recycled and reused, or can be returned to the platform or be returned to a nearby logistics service node, which then return it to the platform.

In the process of logistics operation, the transfer of the goods along the logistics route is transparent and traceable to the consigner and consignee, who can track the goods to every node according to the unique ID. However, the nodes in charge of the logistics operation can only learn that there will be goods to reach it after the upstream node has submitted or signed for the goods to the platform, and then it either goes to pick it up, or waits for the upstream node to deliver; and the node can only learn which node the goods is to go after signing for the goods to the platform. Every node shall take full responsibility for the signed goods until it is delivered to the next node, such that the user's goods can safely reach the destination. All these operations take place under the control and support of the intelligent logistics distribution platform of the present invention.

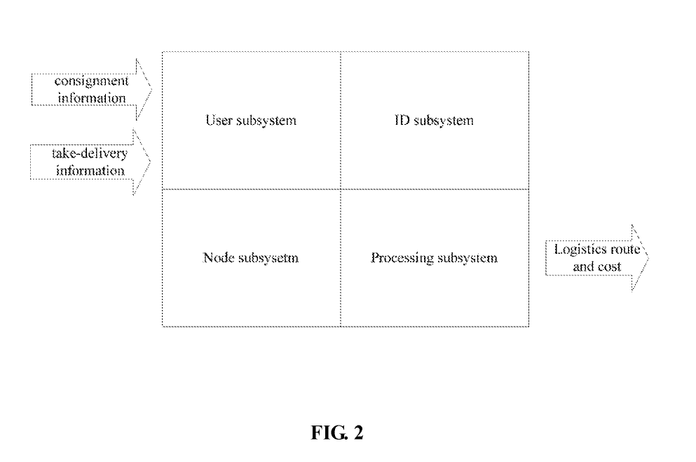

The intelligent logistics distribution platform will be described in detail in the following with reference to FIG. 2. The intelligent logistics distribution platform is an Internet-based management information system platform. As shown in FIG. 2, the platform comprises four subsystems, namely the user subsystem, the ID subsystem, the node subsystem and the processing subsystem. The user subsystem is mainly used for maintaining the consignee and consigner's address information, their respective access nodes, and logistics operation expense. The consigner is responsible for providing consignment information and goods information (e.g. weight, volume, price) required by the system; and the consignee is responsible for providing information in regard to taking delivery. The ID subsystem manages and maintains the unique ID in each logistics service to make sure that there is no ID repetition in the logistics operation. Besides, the user can make a whole course tracking of the logistics operation according to the ID. In the platform, the ID is related to both the consignment information and the take-delivery information. The node subsystem is used for maintaining node information, relationships between nodes, and service price and service time of the node. The establishment of the relationships between nodes forms a logistics service network. The processing subsystem is configured to form a shortest logistics route for the delivery ID based on the delivery information, information of taking delivery, and relationships between nodes and to calculate the logistics expense based on the goods information in the delivery information and the service prices between nodes. The processing subsystem can also manage and supervise the logistics operation of goods between nodes.

The core of this platform is management of users, which can be divided into two types: one is users providing logistics services, such as owners of CDC, RDC, DC and Hub nodes, and this type of users register nodes and manage and maintain nodes according to the aforementioned rules and requirements, and undertakes the logistics operation; the other is users consuming logistics services, who register to the platform to use the logistics functions of the respective nodes and to send their goods from the consigner to the consignee. The second type of users can be further divided into individual users and business users. The other management focus of the platform is management of the goods shipment. When a user consuming logistics services needs to ship his goods, the consigner and consignee must first access the nodes capable of providing logistics services to them in the platform. Then the consigner places his goods in the standard box provided by the platform, and sticks to the box the sealing labels issued by the platform, or other ID identifiers issued by the platform (e.g. RFID tag, bar code, two dimensional code and so on), then tells the platform of ID of the standard box or other unique ID of this consignment, then submits the consignment to the platform. Each node forwards the goods according to the above described rules until the goods safely reach the consignee. The consignee signs to the platform to indicate the completion of this consignment. Of course, all the logistics charges are borne by the logistics service consuming user. Besides, the platform needs to be capable of providing and reclaiming the standard box, providing ID, managing and issuing sealing labels, as well as calculating expenses.

Now a brief description of standard box is given. To protect environment, the use of paper cartons should be reduced. The logistics consignment may also use standard boxes, which are made of reclaimable and durable plastics embedded with RFID tags. The unique code in RFID is the only identifier for delivery. Standard boxes can be retrieved at the node connected to the consignee, or be kept by the consignee for next use. There can be a plurality of specifications for the standard box based on its volume, size and weight. According to the difference of use of logistics consignment, the standard box can be classified into: (1) General goods delivery: opaque, air proof; (2) vegetable standard box: porous, air permeable and (3) Garbage bins: air proof to a certain extent. As a bearing tool for goods, the standard box can be used as a bearing tool after the completion of one consignment. The repeated use of the standard box can greatly reduce cost of consignment and save additional paper package for the user, thus being environment friendly. The platform administrator is responsible for the manufacture of the standard box, and sale as a commodity over the platform. The user may freely apply on the platform for the standard box, and the logistics service nodes can also apply in advance, and then the logistics consuming user can purchase it nearby, thus facilitating delivery for the consigner. Sealing labels are used with standardizing boxes. The user files an application with the platform, which manufactures a disposable RFID paper tag containing the user ID according to the user application. When it's time to deliver goods, the consigner may seal up a standard box using a sealing label so as to prevent the box from being opened during the delivery.

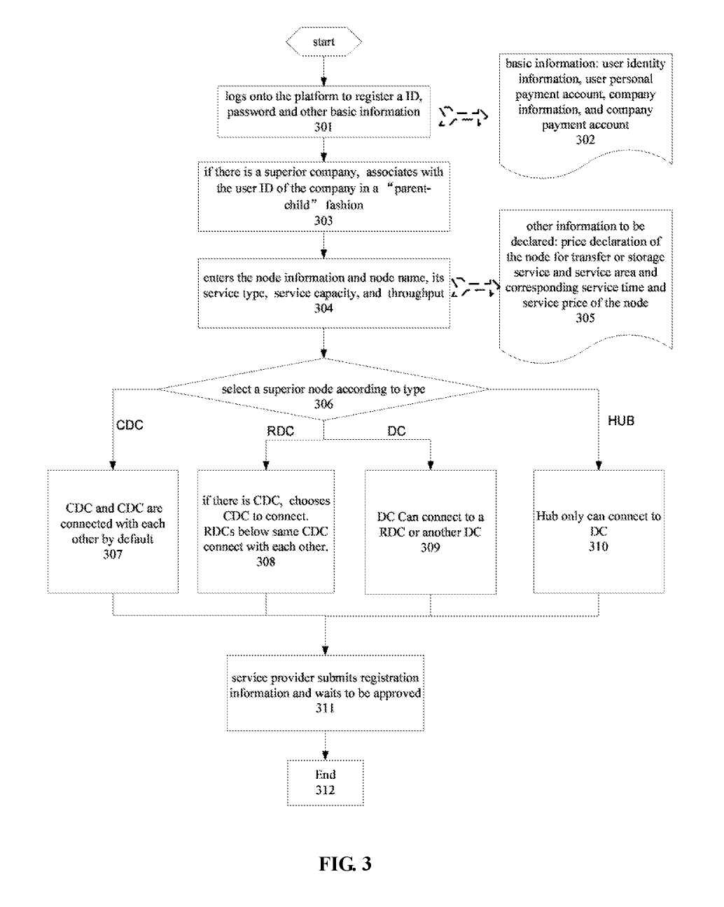

In the following the account application and registration of the logistics service provider node in the platform is described with reference to FIG. 3. If a logistics service provider wants to join in the logistics system as shown in FIG. 1, it needs to register in the platform first. As shown in FIG. 3, at step 301, the service provider (e.g. a logistics company) logs onto the platform to register a user ID and password, and other basic information. As shown in block 302, said basic information includes user identity information, user personal payment account, company information, and company payment account. At step 303, if there is a superior company in the platform, then the registered user ID is associated with the user ID of superior company in a “parent-child” fashion. At step 304, the service provider enters the node information and node name, determines its service type and enters its service capacity, daily throughput and weekly throughput, and declares other information at the same time. As shown in block 305, other information that needs to be declared includes: price declaration of the node for transfer or storage service and service area and corresponding service time and service price of the node. At step 306, the service provider selects a superior node according to its own type. If the service provider is a CDC, then as shown in block 307, CDC and CDC are connected with each other by default, logistics services, the price and income distribution between CDCs are negotiated between such three parties as the two CDCs and the platform and the connectedness between CDCs needs to be approved by the platform to go into effect. If the service provider is an RDC, then as shown in block 308, if there is any CDC in the platform, the RDC can choose a CDC to connect. The logistics service between a CDC and an RDC is provided by the CDC, and the service rate and service time are defined by the CDC. In this case the platform takes responsibility for supervision and management. The RDCs below the same CDC are connected with each other by default. The logistics services and rate income between an RDC and another RDC are negotiated between such three parties as the RDCs and the platform. The connectedness between RDCs needs to be approved by the platform to go into effect. If the service provider is a DC, then as shown in block 309, if the DC chooses to connect to an RDC, then the RDC is responsible for the logistics services, and the service rate and service time are prescribed by the RDC. And the platform takes responsibility for supervision and management. The connectedness between the DC and RDC needs to be approved by the RDC to go into effect. However, if the DC chooses to connect to another DC, the upstream DC takes responsibility for the logistics services, and the service rate and service time are prescribed by the upstream DC. And the platform takes responsibility for supervision and management. The connectedness between these two DCs needs to be approved by the upstream DC to go into effect. If the service provider is a hub, then as shown in block 310, the hub can only choose to connect to a DC, and the DC takes responsibility for the logistics services, and the rate and service time are also prescribed by the upstream DC. The platform takes responsibility for supervision. The connectedness between the hub and the DC needs to be approved by the DC to go into effect. At step 311, the service provider submits registration information to the platform, and waits for its roles to be approved by the platform. At step 312, the process of service provider registration in the platform is ended. Once the service provider is successfully registered in the platform, the platform maintains its information as well as its relationships with other nodes, and the node represented by the service provider is added to the logistics network as shown in FIG. 1 and is ready to participate in any upcoming logistics service. As more and more service providers register in the platform, the logistics network as shown in FIG. 1 accordingly expands.

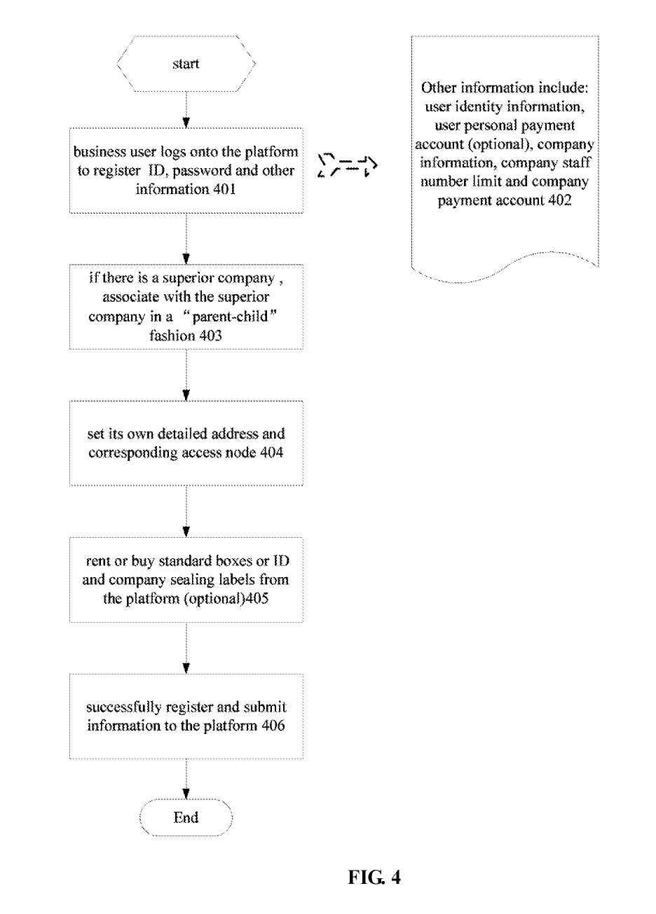

The account application and registration of logistics services consuming business user in the platform is described with reference to FIG. 4. If a business user consuming logistics service wants to obtain logistics service from the logistics system shown in FIG. 1, it needs first to register in the platform. As shown in FIG. 4, at step 401, the business user logs onto the platform to register company administrator ID and password, and other basic information. Said basic information includes: user identity information, user personal payment account (optional), company information, company staff number limit and company payment account, wherein the company staff number limit means that there is a upper limit for the number of company staff. At step 403, if there is a superior company in the platform, the business user account is associated with the account of the superior company in a “parent-child” fashion. At step 404, the business user sets its own detailed address and corresponding access node. Please be noted that the business user may set a plurality of addresses and corresponding access nodes. Only one address and one node is by default for common use. At step 405, the business user rents or buys standard boxes or ID as well as company sealing labels from the platform. Step 405 is optional. The box should be prepared before the delivery of goods. At step 406, the business user successfully registers and submits information to the platform. At step 407, the registration of the business user is ended.

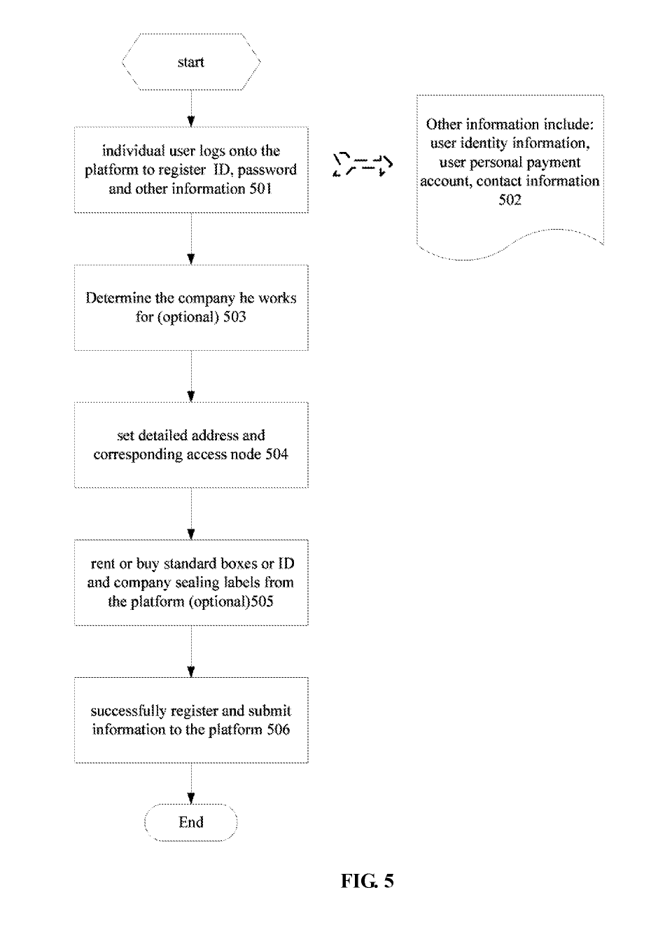

The account application and registration of logistics services consuming individual user in the platform is described with reference to FIG. 5. If an individual user wants to obtain logistics service from the logistics system shown in FIG. 1, the individual user also needs to register in the platform. The process in FIG. 5 is similar to that in FIG. 4. As shown in FIG. 5, at step 501, an individual user logs onto the platform to register a user ID and password as well as other basic information. As shown in block 502 said basic information includes: user identity information, contact information, such as email, telephone etc, and user personal payment account. At step 503, the individual user needs to determine the company he/she belongs to, select the management account ID of the company to make a “parent-child” association, and choose his/her post. Please be noted that step 503 is optional and is only performed for key personnel of a node or logistics consuming business. At step 504, the individual user set his detailed address and corresponding access node. The user may set a plurality of addresses and corresponding access nodes. However, only one address and one node are by default for common use. At step 505, the individual user rents or buys standard boxes or ID as well as personal sealing labels from the platform to prepare for delivery. Please be noted that step 505 is also optional and the box or ID only needs to be prepared before consignment. At step 506, the individual user successfully registers and submits information to the platform. At step 506, the registration process for the individual user is ended.

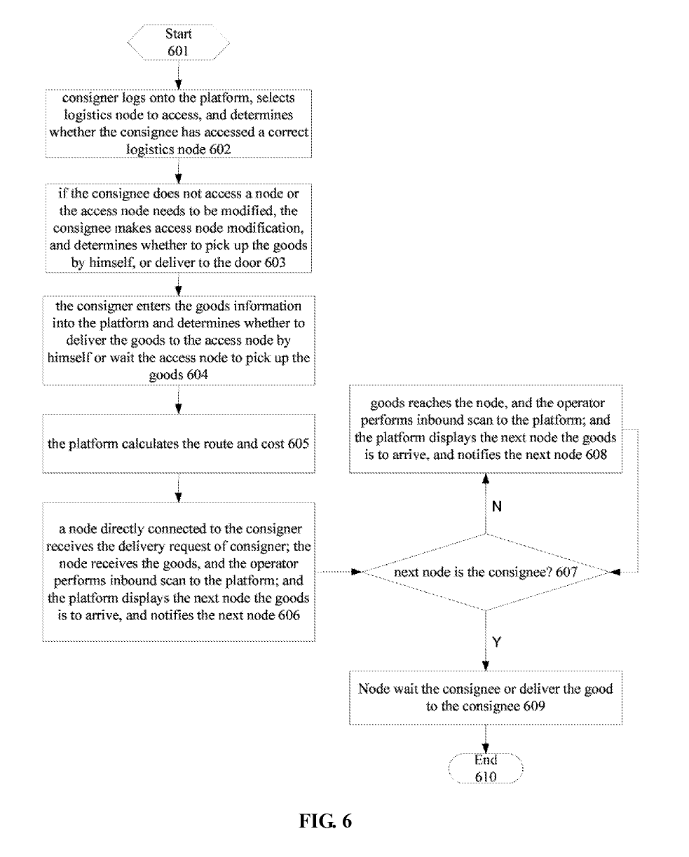

In the following the method for providing logistics service using the logistics system of the present invention is described in detail with reference to FIG. 6. The logistics process starts at step 601, wherein a logistics service consuming user needs to ship goods to others, and the goods are already packed. The standard box or other package embedded with ID warrants issued by the system can be used for packing. According to an embodiment of the present invention, the standard box uses sealing labels. At step 602, the consigner logs onto the platform, selects a correct logistics node to access, and determines whether the consignee has accessed a correct logistics node. At step 603, if the consignee does not access a node or the access node needs to be modified, the consignee makes access node modification, and determines whether to pick up the goods by himself, or deliver to the door. Delivery to the door requires the consignee to provide his address in detail. At step 604, the consigner enters the goods information into the platform, makes sure that the ID entered into the platform is consistent with the ID of the standard box used for the goods or other ID warrants of this consignment, and enters into the platform information about the good such as its value, weight, shape, volume and precautions. Besides, the consigner determines whether to deliver the goods to the access node by himself or wait the access node to pick up the goods. If he chooses to wait the access node to pick up the goods, then the consigner is required to enter his detailed address and contacts. At step 605, the platform calculates the route of the goods based on the access nodes of the consigner and the consignee, and in combination with the goods information such as its weight, calculates the logistics expense of this logistics service, and if necessary calculates the insurance expense. Who shall pay the total expenses is to be negotiated by the consigner and the consignee. According to an embodiment, for standard box or reclaimable permanent ID, the consignee needs to pay deposit for the consigner. In one embodiment of the present invention, only after the payment will this consignment be successfully submitted to the platform. In another embodiment, the expenses can be paid after the delivery. The logistics operation starts after the consigner submits the delivery request. At step 606, a node directly connected to the consigner receives the delivery request of consigner, and if it requires pick-up service, the node sends someone to pick up the goods; if the consigner sends the goods to the node himself, then the node will wait for the goods. After the node receives the goods, the operator in the node performs an inbound scan to the platform or signs manually, and checks the weight of the goods. The platform displays the next node the goods is to arrive, and notifies the next node there will be goods arriving at the same time. The transport of goods between nodes is carried out according to predefined rules described above. At step 607, it is determined whether the next node is the consignee. If yes, then the process continues to step 609, where if the consignee chooses to pick up the goods by himself, then the node does nothing but waits for the consignee; if the consignee chooses delivery to the door, then the node needs to deliver the goods to the consignee. After receiving the goods, the consignee signs for the goods to the platform. When the logistics operation completes, the standard box or permanent RFID can be returned to the nearest node or sent back to the platform. If at step 607 it is determined that the next node is not the consignee, then the process continues to step 608, where the node performs inbound scan to the goods arriving at the node or manually signs for it. The platform displays the next node the goods is to arrive, and notifies the next node there will be goods arriving. The transport of goods between nodes is carried out according to the predefined rules. At step 610, the process ends.

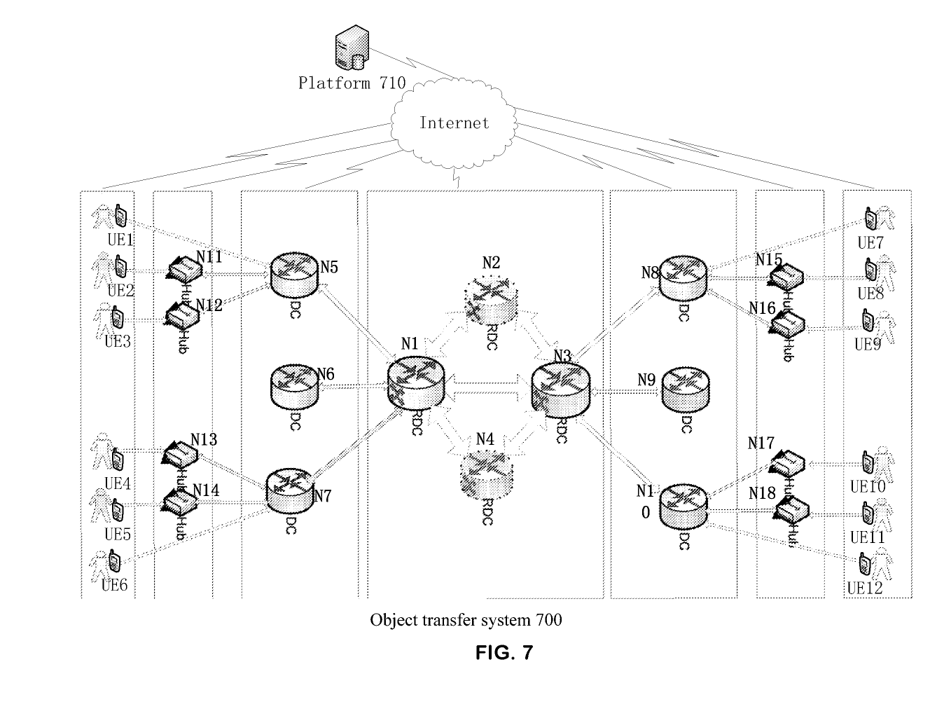

FIG. 7 illustrates the schematic diagram of an object transfer system 700 according to the present invention. The object transfer system 700 is used for transferring an object across one or more geographical areas, and comprises an intelligent object distribution platform 710, a plurality of nodes N1, N2, . . . , each located in a respective geographical area. The platform 710, the respective node computers located in the nodes and users' terminals UE1, UE2, . . . , are configured to communicate with each other in a wired manner or in a wireless manner, for example by means of Internet as shown.

The plurality of nodes are configured to provide object transfer function. Each of the nodes have for example a node computer provided therein, and the node computer is configured to send information about node to the platform, and to send a message that an object arrives at the node to the platform when the object arrives.

Users' terminals can be cellphones as shown, or any other communication devices enabled to communicate with nodes and the platform in a wired manner or in a wireless manner. Each of users' terminals is configured to send user information and information about object provided by a user to the platform directly or via one of the nodes.

The platform may be implemented on a server comprising one or more computers and is configured to:

receive information about node from the respective nodes, receiving a message that an object arrives at a node from the node, and receive user information and information about object from a user or from a node; as an example, the information about node including relationships between nodes, service scope, service price, and processing capacity of nodes; the information about object including the source address, the destination address, the weight and the volume of an object; the user information includes address information of a consigner and a consignee, their respective access nodes;

maintain information about node, maintain user information, and manage and maintain a unique ID for each object, the location of the object, and the information about the object;

associate nodes located in each geographical area to form a number of tree structures with respective roots of said trees being connected with each other, wherein each geographical area comprises a plurality of regions, each of which in turn comprises a plurality of sub-regions, and in each tree structure a root is formed by a Regional Distribution Center and non-root nodes in each tree structure are each formed by a Distribution Center or a hub, which Distribution Center must have one and only one connection to its parent node and its parent node can be another Distribution Center or a Regional Distribution Center, which hub can only be a leaf of the tree structure, it has only one parent node and its parent node can only be a Distribution Center; wherein said roots in each geographical area are all connected to one of other nodes which are not part of any tree structure and which in turn are connected to each other; and wherein a Distribution Center is responsible for delivery in a sub-region and a Regional Distribution Center is responsible for delivery across regions or across sub-regions, said other nodes are formed by Country Distribution Centers which are responsible for delivery across geographical areas;

select for the object a source node and a destination node corresponding to the source address and the destination address respectively;

select a route associated with the unique ID of the object based on the user information, the information about object and the information about node; and

instruct the nodes on the selected route to transport the object; wherein in response to receiving a message from a node that an object has arrived at the node, the platform sends a message to inform the node of the next node in the unique shortest route for the object, and sends a message to inform the next node there will be an object arriving at.

In an example, the platform is further configured to derive a shortest route from the source node to the destination node for the object based on the topology of the connected nodes and the distances between nodes. For example, to derive the shortest route from node N13 to node N16, since Node N13 has only one route to node N1 (i.e., N13-N7-N1), similarly, node N16 has only one route to node N3 (i.e., N16-N8-N3), and the distances between nodes N1-N4 can be obtained based on the relationships between nodes, a shortest route from node N1 to node N3 can be derived using a shortest path algorithm such as Dijkstra's Shortest Path Algorithm, then a shortest route from node N13 to node N16 can be derived accordingly.

In another example, the platform is further configured to derive an optimal route from the source node to the destination node for the object based on the topology of the connected nodes, and factors such as the distances between nodes, the transfer time between nodes, and the transfer latency for object at respective nodes, etc. The transfer time between two nodes may not only depend on the distance between the two nodes, but also depend on the transfer manner, for example, an object may be transferred through different ways when being transferred between different pairs of nodes, for example, by train, by air or by road transportation etc. The transfer latency for object at a node may depend on the number of objects which are currently stored at the node and waiting for being forwarded. To derive an optimal route from the source node to the destination node for the object, the above factors may be assigned weights as required and then summed to obtain logical distances between nodes, and then an optimal route may be derived using a shortest path algorithm such as Dijkstra's Shortest Path Algorithm. For example, to derive an optimal route from node N13 to node N16, since Node N13 has only one route to node N1 (i.e., N13-N7-N1), similarly, node N16 has only one route to node N3 (i.e., N16-N8-N3), and the logical distances between nodes N1-N4 can be obtained as mentioned above, an optimal route from node N1 to node N3 can be derived, and an optimal route from node N13 to node N16 can be derived accordingly.

In another example, the platform is further configured to, during the process of transferring an object, if any of the nodes on the selected route fails or connection between any two neighboring nodes on the selected route is broken and thus the topology of the nodes changes, reselect a route associated with the unique ID of the object based on the updated topology of the nodes and instruct the nodes on the reselected route to transport the object. For example, due to bad weathers etc., it is impossible to transfer an object between two neighboring nodes on the selected route, i.e., the connection between the two nodes is broken, or a node cannot work normally, i.e., the node fails, the platform is informed of such information by relevant nodes to update the topology of the nodes accordingly. Then, to avoid the situation that the transfer for an object is delayed too much or even cannot be accomplished due to the failures of nodes or connection between any two neighboring nodes on the selected route, the platform is configured to reselect a route for the object and instruct the nodes on the reselected route to transport the object.

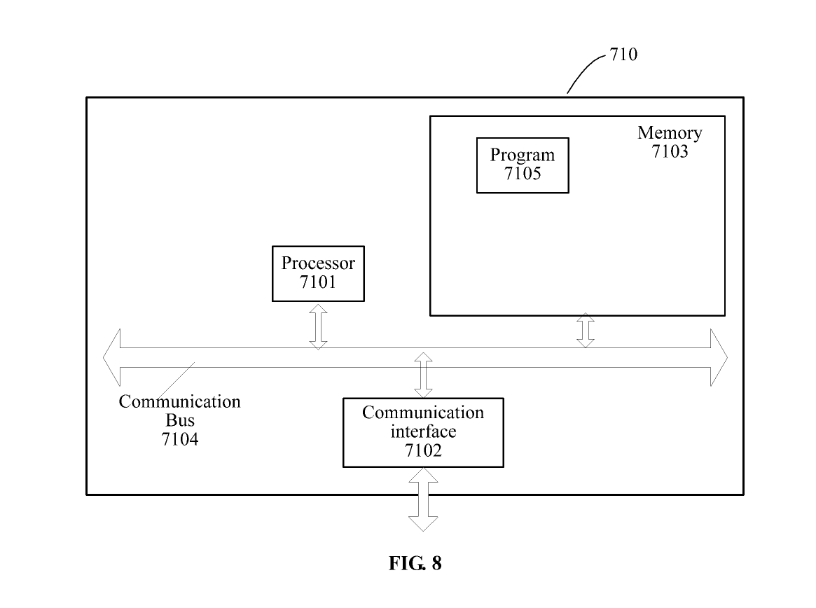

FIG. 8 illustrates the block diagram of intelligent object distribution platform 710 for use in transferring an object from a source address to a destination address through nodes across one or more geographical areas, wherein the platform, the nodes and users can communicate with each other in a wired manner or in a wireless manner. The platform 710 may be implemented on a server which may comprise: a processor 7101, a communication interface 7102, a memory 7103, and a communication bus 7104.

The processor 7101, the communication interface 7102, and the memory 7103 communicate with each other through the communication bus 7104. The communication interface 7102 is configured to communicate with a node or a user's terminal. The processor 7101 is configured to execute a program 7105. Specifically, the program 7105 may comprise program code, the program code comprising program instructions.

The processor 7101 may be a central processing unit (CPU), or an application specific integrated circuit (ASIC), or be configured as one or more integrated circuits for implementing the embodiments of the present application. The memory 7103 is configured to store the program 7105. The memory 7103 may comprise a high-speed random access memory (RAM), and may also comprise a non-volatile memory, for example, at least one magnetic disk memory. The program 7105 may be specifically configured to cause the platform 710 to perform the following operations:

receiving information about node from the respective nodes, receiving a message that an object arrives at a node from the node, and receiving user information and information about object from a user or from a node; for example, the information about node including relationships between nodes, service scope, service price, and processing capacity of nodes; the information about object including the source address, the destination address, the weight and the volume of an object; the user information includes address information of a consigner and a consignee, their respective access nodes;

maintaining information about node, maintaining user information, and managing and maintaining a unique ID for each object, the location of the object, and the information about the object;

associating nodes located in each geographical area to form a number of tree structures with respective roots of said trees being connected with each other, wherein each geographical area comprises a plurality of regions, each of which in turn comprises a plurality of sub-regions, and in each tree structure a root is formed by a Regional Distribution Center and non-root nodes in each tree structure are each formed by a Distribution Center or a hub, which Distribution Center must have one and only one connection to its parent node and its parent node can be another Distribution Center or a Regional Distribution Center, which hub can only be a leaf of the tree structure, it has only one parent node and its parent node can only be a Distribution Center; wherein said roots in each geographical area are all connected to one of other nodes which are not part of any tree structure and which in turn are connected to each other; and wherein a Distribution Center is responsible for delivery in a sub-region and a Regional Distribution Center is responsible for delivery across regions or across sub-regions, said other nodes are formed by Country Distribution Centers which are responsible for delivery across geographical areas;

selecting for the object a source node and a destination node corresponding to the source address and the destination address respectively;

selecting a route associated with the unique ID of the object based on the user information, the information about object and the information about node; and

instructing the nodes on the selected route to transport the object; wherein in response to receiving a message from a node that an object has arrived at the node, sending a message to inform the node of the next node in the unique shortest route for the object, and sending a message to inform the next node there will be an object arriving at.

In an example, selecting a route associated with the unique ID of the object comprises: deriving a shortest route from the source node to the destination node for the object based on the topology of the connected nodes and the distances between nodes.

In another example, selecting a route associated with the unique ID of the object comprises: deriving an optimal route from the source node to the destination node for the object based on the topology of the connected nodes, the distances between nodes, the transfer time between nodes, and the transfer latency for object at respective nodes.

In another example, the program 7105 may be configured to cause the platform 710 to perform the following operation of: during the process of transferring an object, if any of the nodes on the selected route fails or connection between any two neighboring nodes on the selected route is broken, reselecting a route associated with the unique ID of the object based on the updated topology of the nodes and instructing the nodes on the reselected route to transport the object.

In another example, the program 7105 may be configured to cause the platform 710 to perform the following operation of: controlling the process of transferring an object through nodes across one or more geographical areas according to the unique ID.

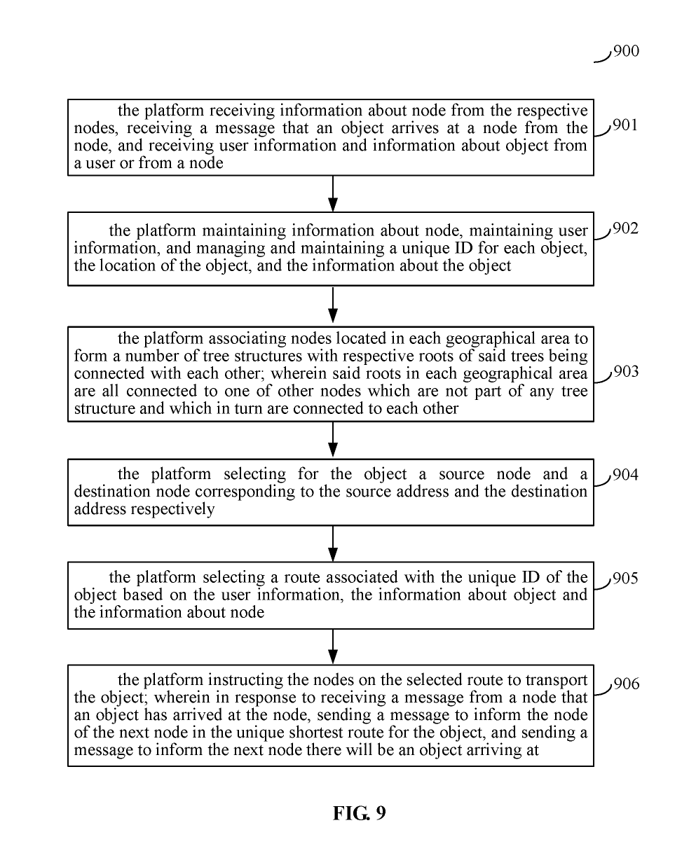

FIG. 9 illustrates a flow chart of a method 900 method for transferring an object from a source address to a destination address across one or more geographical areas through nodes located in said geographical areas by means of an intelligent object distribution platform. The platform, the nodes and users can communicate with each other in a wired manner or in a wireless manner.

The method 900 comprises the following steps:

S901: the platform receiving information about node from the respective nodes, receiving a message that an object arrives at a node from the node, and receiving user information and information about object from a user or from a node;

S902: the platform maintaining information about node, maintaining user information, and managing and maintaining a unique ID for each object, the location of the object, and the information about the object;

S903: the platform associating nodes located in each geographical area to form a number of tree structures with respective roots of said trees being connected with each other, wherein each geographical area comprises a plurality of regions, each of which in turn comprises a plurality of sub-regions, and in each tree structure a root is formed by a Regional Distribution Center and non-root nodes in each tree structure are each formed by a Distribution Center or a hub, which Distribution Center must have one and only one connection to its parent node and its parent node can be another Distribution Center or a Regional Distribution Center, which hub can only be a leaf of the tree structure, it has only one parent node and its parent node can only be a Distribution Center; wherein said roots in each geographical area are all connected to one of other nodes which are not part of any tree structure and which in turn are connected to each other; and wherein a Distribution Center is responsible for delivery in a sub-region and a Regional Distribution Center is responsible for delivery across regions or across sub-regions, said other nodes are formed by Country Distribution Centers which are responsible for delivery across geographical areas;

S904: the platform selecting for the object a source node and a destination node corresponding to the source address and the destination address respectively;

S905: the platform selecting a route associated with the unique ID of the object based on the user information, the information about object and the information about node; and

S906: the platform instructing the nodes on the selected route to transport the object; wherein in response to receiving a message from a node that an object has arrived at the node, sending a message to inform the node of the next node in the unique shortest route for the object, and sending a message to inform the next node there will be an object arriving at.

In an example, selecting a route associated with the unique ID of the object comprises: deriving a shortest route from the source node to the destination node for the object based on the topology of the connected nodes and the distances between nodes.

In another example, selecting a route associated with the unique ID of the object comprises: deriving an optimal route from the source node to the destination node for the object based on the topology of the connected nodes, the distances between nodes, the transfer time between nodes, and the transfer latency for object at respective nodes.

In another example, the method 900 further comprises: during the process of transferring an object, if any of the nodes on the selected route fails or connection between any two neighboring nodes on the selected route is broken, the platform reselecting a route associated with the unique ID of the object based on the updated topology of the nodes and instructing the nodes on the reselected route to transport the object.

Further, embodiments of the present application provide a storage medium, which is used to store an application program, the application program being used to perform a method for transferring an object provided by embodiments of the present application when being executed on a computer comprising a processor.

Those of ordinary skills in the art can understand that all or part of the processes of the above embodiments of a method can be realized by means of instructing related hardware with computer programs, the program can be stored in a computer readable storage medium, and can include said processes of the various embodiments of a method when executed. Wherein, the storage medium may be a diskette, an optical disc, a Read-Only Memory (ROM) or a Random Access Memory (referred to as RAM) and the like.

The logistics system of the present invention can bring revolutionary changes in logistics industry. For example, it can organize a logistics service network that is able to cover the global scope. The present invention will build a logistics network that is fully reciprocal and open. Every individual, every logistics company, or every society organization in the world can participate in the platform as a service provider, or a service consumer. People anywhere in the world only can access Internet will are available through the platform to get logistics services. Covering global logistics service will help to eliminate regional disparities and poverty, promote global integration and economic prosperity. The logistics system of the present invention can reduce the global logistics service cost by 5%˜10%. The platform uses Conservation Act to optimize the best path. It can ensure that every time logistics and distribution service is based on the best path. The platform can significantly reduce the cost of logistics and distribution. The logistics system of the present invention can control the ratios of lost goods and mistakenly delivery below 6c. The logistics system of the present invention can strengthen the social division of labor. The platform divides the end to end logistics and distribution services into several independent processes, so that the logistics companies are more focused on their business, resulting in deepened social division of labor that is conducive to reducing the cost of logistics services. The logistics system of the present invention can solve the last mile logistics problems. The logistics system of the present invention can may contribute to green global environment. It could make the logistics no longer need the traditional single-5 transport bills. Moreover, the logistics system of the present invention can support unemployed people joining the logistics system to provide logistics and distribution services so that the issue of unemployment is solved.

What is claimed is:

1. An intelligent object distribution platform for use in transferring an object from a source address to a destination address through nodes across one or more geographical areas, wherein the platform, the nodes and users can communicate with each other in a wired manner or in a wireless manner, said platform comprises a processor and a memory, the memory comprises computer programs which are executed by the processor to perform the operations of:
receiving information about node from the respective nodes, receiving a message that an object arrives at a node from the node, and receiving user information and information about object from a user or from a node;
maintaining information about node, maintaining user information, and managing and maintaining a unique ID for each object, the location of the object, and the information about the object;
associating nodes located in each geographical area to form a number of tree structures with respective roots of said trees being connected with each other, wherein each geographical area comprises a plurality of regions, each of which in turn comprises a plurality of sub-regions, and in each tree structure a root is formed by a Regional Distribution Center and non-root nodes in each tree structure are each formed by a Distribution Center or a hub, which Distribution Center must have one and only one connection to its parent node and its parent node can be another Distribution Center or a Regional Distribution Center, which hub can only be a leaf of the tree structure, it has only one parent node and its parent node can only be a Distribution Center; wherein said roots in each geographical area are all connected to one of other nodes which are not part of any tree structure and which in turn are connected to each other; and wherein a Distribution Center is responsible for delivery in a sub-region and a Regional Distribution Center is responsible for delivery across regions or across sub-regions, said other nodes are formed by Country Distribution Centers which are responsible for delivery across geographical areas;
selecting for the object a source node and a destination node corresponding to the source address and the destination address respectively;
selecting a route associated with the unique ID of the object based on the user information, the information about object and the information about node; and
instructing the nodes on the selected route to transport the object; wherein in response to receiving a message from a node that an object has arrived at the node, sending a message to inform the node of the next node in the unique shortest route for the object, and sending a message to inform the next node there will be an object arriving at.

2. The intelligent object distribution platform of claim 1, wherein selecting a route associated with the unique ID of the object comprises: deriving a shortest route from the source node to the destination node for the object based on the topology of the connected nodes and the distances between nodes.

3. The intelligent object distribution platform of claim 1, wherein selecting a route associated with the unique ID of the object comprises: deriving an optimal route from the source node to the destination node for the object based on the topology of the connected nodes, the distances between nodes, the transfer time between nodes, and the transfer latency for object at respective nodes.

4. The intelligent object distribution platform of claim 1, wherein the computer programs are executed by the processor to perform the operation of: during the process of transferring an object, if any of the nodes on the selected route fails or connection between any two neighboring nodes on the selected route is broken, reselecting a route associated with the unique ID of the object based on the updated topology of the nodes and instructing the nodes on the reselected route to transport the object.

5. The intelligent object distribution platform of claim 1, wherein the computer programs are executed by the processor to perform the operations of: controlling the process of transferring an object through nodes across one or more geographical areas according to the unique ID.

6. The intelligent object distribution platform of claim 1, wherein the information about node including relationships between nodes, service scope, service price, and processing capacity of nodes; the information about object including the source address, the destination address, the weight and the volume of an object; the user information includes address information of a consigner and a consignee, their respective access nodes.

7. The intelligent object distribution platform of claim 1, wherein said unique ID comprises Radio-Frequency Identification (RFID), two dimensional codes, bar codes or an ID on a standard box.

8. The intelligent object distribution platform of claim 7, wherein the standard box is made of plastics and can be reused many times and recycled, and said standard box can be sealed by sealing label that issued by the platform to protect the things in the box.

9. An object transfer system for transferring an object from a source address to a destination address through nodes across one or more geographical areas, the system comprising an intelligent object distribution platform and a plurality of nodes each located in a respective geographical area, wherein the platform, the nodes and users can communicate with each other in a wired manner or in a wireless manner, wherein,
the nodes are configured to provide object transfer function, to send information about node to the platform, and to send a message that an object arrives at the node to the platform when the object arrives;
the platform is configured to:
receive information about node from the respective nodes, receiving a message that an object arrives at a node from the node, and receive user information and information about object from a user or from a node;
maintain information about node, maintain user information, and manage and maintain a unique ID for each object, the location of the object, and the information about the object;
associate nodes located in each geographical area to form a number of tree structures with respective roots of said trees being connected with each other, wherein each geographical area comprises a plurality of regions, each of which in turn comprises a plurality of sub-regions, and in each tree structure a root is formed by a Regional Distribution Center and non-root nodes in each tree structure are each formed by a Distribution Center or a hub, which Distribution Center must have one and only one connection to its parent node and its parent node can be another Distribution Center or a Regional Distribution Center, which hub can only be a leaf of the tree structure, it has only one parent node and its parent node can only be a Distribution Center; wherein said roots in each geographical area are all connected to one of other nodes which are not part of any tree structure and which in turn are connected to each other; and wherein a Distribution Center is responsible for delivery in a sub-region and a Regional Distribution Center is responsible for delivery across regions or across sub-regions, said other nodes are formed by Country Distribution Centers which are responsible for delivery across geographical areas;
select for the object a source node and a destination node corresponding to the source address and the destination address respectively;
select a route associated with the unique ID of the object based on the user information, the information about object and the information about node; and
instruct the nodes on the selected route to transport the object; wherein in response to receiving a message from a node that an object has arrived at the node, the platform sends a message to inform the node of the next node in the unique shortest route for the object, and sends a message to inform the next node there will be an object arriving at.

10. The object transfer system of claim 9, wherein the platform is further configured to derive a shortest route from the source node to the destination node for the object based on the topology of the connected nodes and the distances between nodes.

11. The object transfer system of claim 9, wherein the platform is further configured to derive an optimal route from the source node to the destination node for the object based on the topology of the connected nodes, the distances between nodes, the transfer time between nodes, and the transfer latency for object at respective nodes.

12. The object transfer system of claim 9, wherein the platform is further configured to, during the process of transferring an object, if any of the nodes on the selected route fails or connection between any two neighboring nodes on the selected route is broken, reselect a route associated with the unique ID of the object based on the updated topology of the nodes and instruct the nodes on the reselected route to transport the object.

13. The object transfer system of claim 9, wherein the platform is further configured to control the process of transferring an object through nodes across one or more geographical areas according to the unique ID.

14. The object transfer system of claim 9, wherein the information about node including relationships between nodes, service scope, service price, and processing capacity of nodes; the information about object including the source address, the destination address, the weight and the volume of an object; the user information includes address information of a consigner and a consignee, their respective access nodes.

15. The object transfer system of claim 9, wherein said unique ID comprises Radio-Frequency Identification (RFID), two dimensional codes, bar codes or an ID on a standard box.

16. A method for transferring an object from a source address to a destination address across one or more geographical areas through nodes located in said geographical areas by means of an intelligent object distribution platform, wherein the platform, the nodes and users can communicate with each other in a wired manner or in a wireless manner, said method comprising,
the platform receiving information about node from the respective nodes, receiving a message that an object arrives at a node from the node, and receiving user information and information about object from a user or from a node;
the platform maintaining information about node, maintaining user information, and managing and maintaining a unique ID for each object, the location of the object, and the information about the object;
the platform associating nodes located in each geographical area to form a number of tree structures with respective roots of said trees being connected with each other, wherein each geographical area comprises a plurality of regions, each of which in turn comprises a plurality of sub-regions, and in each tree structure a root is formed by a Regional Distribution Center and non-root nodes in each tree structure are each formed by a Distribution Center or a hub, which Distribution Center must have one and only one connection to its parent node and its parent node can be another Distribution Center or a Regional Distribution Center, which hub can only be a leaf of the tree structure, it has only one parent node and its parent node can only be a Distribution Center; wherein said roots in each geographical area are all connected to one of other nodes which are not part of any tree structure and which in turn are connected to each other; and wherein a Distribution Center is responsible for delivery in a sub-region and a Regional Distribution Center is responsible for delivery across regions or across sub-regions, said other nodes are formed by Country Distribution Centers which are responsible for delivery across geographical areas;
the platform selecting for the object a source node and a destination node corresponding to the source address and the destination address respectively;
the platform selecting a route associated with the unique ID of the object based on the user information, the information about object and the information about node; and
the platform instructing the nodes on the selected route to transport the object; wherein in response to receiving a message from a node that an object has arrived at the node, sending a message to inform the node of the next node in the unique shortest route for the object, and sending a message to inform the next node there will be an object arriving at.

17. The method of claim 16, wherein selecting a route associated with the unique ID of the object comprises: deriving a shortest route from the source node to the destination node for the object based on the topology of the connected nodes and the distances between nodes.

18. The method of claim 16, wherein selecting a route associated with the unique ID of the object comprises: deriving an optimal route from the source node to the destination node for the object based on the topology of the connected nodes, the distances between nodes, the transfer time between nodes, and the transfer latency for object at respective nodes.

19. The method of claim 16, wherein during the process of transferring an object, if any of the nodes on the selected route fails or connection between any two neighboring nodes on the selected route is broken, the platform reselecting a route associated with the unique ID of the object based on the updated topology of the nodes and instructing the nodes on the reselected route to transport the object.

20. The method of claim 16, wherein the platform controls the process of transferring an object through nodes across one or more geographical areas according to the unique ID.
